(19) United States
(12) Patent Application Publication
(10) Pub. No.: US 2026/0208447 A1
(43) Pub. Date: Jul. 23, 2026

(54) METHOD FOR DISPENSING DISCRETE VOLUMES

(71) Applicants: ARBURG GMBH + CO KG, Lossburg (DE); ARBURGADDITIVE GMBH + CO KG, Lossburg (DE)

(72) Inventor: Jan MÖLLER, Freudenstadt (DE)

(21) Appl. No.: 19/136,936

(22) PCT Filed: Dec. 8, 2023
(86) PCT No.: PCT/EP2023/084887

§ 371 Date: Jun. 9, 2025

(30) Foreign Application Priority Data
Dec. 9, 2022 (DE) 10 2022 132 825.2

(51) Int. Cl. B29C 64/393; B29C 48/395; B29C 64/106; B29C 64/209; B29C 64/321; B33Y 10/00; B33Y 50/02

(52) U.S. Cl. CPC B29C 64/393; B29C 48/397; B29C 64/106; B29C 64/209; B29C 64/321; B33Y 10/00; B33Y 50/02

(57) ABSTRACT

The invention relates to a method for dispensing discrete volumes (10) having certain properties along a trajectory in order to produce a three-dimensional object (58) from solidifiable material that is either in a stressed state or is brought into a stressed state, in which method the stressed state of the material is introduced into a material reservoir (74). A pressure (p) is applied to the stressed state in order to discretely dispense the material from a closable outlet opening in order to produce the three-dimensional object (58) under at least one process condition, at least one process parameter being updated in the event of a change in at least one process condition. A reliable, controlled, and reproducible method is provided by providing material-specific data of the material and by using the material-specific data to regulate the at least one process parameter and/or at least one further process parameter in order to obtain at least one predefined property of the discrete volumes (10) in an unstressed state in which no other additional external influences act on the material.

### REFERENCE TO RELATED APPLICATIONS

The present application relates to and claims the priority of German patent application 10 2022 132 825.2, filed on Dec. 9, 2022, the disclosure of which is hereby, in its entirety, made part of the subject matter of the present application.

### TECHNICAL FIELD

The disclosure relates to a method of dispensing discrete volumes with certain properties along a trajectory in order to produce a three-dimensional object and an associated machine control for executing the method, as well as a computer program product for carrying out the method.

The discrete volume is dependent on the properties of mass (m) and density (p). Depending on the dispensing speed of consecutive volumes along a trajectory(s), a dispensed quantity per unit time results, which influences the shear rate and thus the flowability of the material.

The term “unstressed state” as used in this application is to be understood as meaning that in an unstressed state no further external influences act on the material. For example, the material is in an unstressed state at room temperature and/or room pressure. The properties of the material, for example the density, are generally different in the unstressed state, for example at room temperature and/or room pressure, from those in a stressed state, for example at a certain pressure, a certain temperature and/or in a fluid phase of the material.

The term “solidifiable material,” as used in this application, is to be understood broadly and includes in particular, but not only, in addition to plastics, silicone or other thermoplastic and/or elastomeric materials, e.g., ceramic, metallic and/or powdery masses, also paper, cellulose, starch, cork, etc., as well as mixed materials between such plasticizable materials. In principle, these can also be previously plasticized materials or plastic masses that cure automatically or with the use of auxiliary agents after having been dispensed. The term also includes recyclates or compounds.

### BACKGROUND

Various methods are known today for producing a three-dimensional object. For example, the objects can be produced precisely using a machine for handling and/or processing a material, in particular a molding machine or a 3D-printing machine, e.g., a 3D printer. For this purpose, the material is put into the fluid state due to a temperature effect and is dispensed under the influence of pressure either as a material strand or as individual successive discrete volumes from a closable nozzle, whereby the object is produced layer by layer. Such a combination of a dispensing of discrete volumes and a material strand is disclosed, for example, in DE 10 2013 003 167 A1.

However, many interactions of the existing process parameters are present as properties of the volume to be dispensed or the volume flow.

Depending on the dispensed quantity per unit time, the shear of the material changes, for example, as it flows through the dispensing nozzle, which influences the flow properties, which in turn influence the dispensed quantity per unit time if the parameters remain constant. For example, viscosity is a parameter used to describe the flowability of a plastics material under the influence of a given temperature and applied pressure.

Different nozzle diameters or opening gaps, e.g., when using a closure means such as a needle valve, can also result in different shear rates and therefore different flow properties. Manufacturing tolerances can also have an influence, which means that reproducibility between nozzles or shaping machines cannot be guaranteed.

There may also be batch variations in the material that cause different flow properties. The flowability can also be influenced by the moisture content of the material or residual moisture in the material to be processed. Fillers or additives in the material to be processed can also influence the flowability.

To illustrate this, various influences on the shear viscosity and/or the shear rate, e.g., due to the molecular mass, the pressure, a filler, the temperature or a filler, are shown schematically in a diagram in FIG. 6. For example, the shear viscosity decreases with increasing temperature.

Different temperature settings from machine to machine also result in different dispensed quantities. In addition, the shear rates and therefore the flow properties depend on the temperature, which means that different pressure loads must also be applied to the material to be dispensed.

If the process specifies that the dispensed quantity per time unit is to be the same, other parameters must be readjusted, such as the pressure and/or temperature.

DE 10 2012 004 988 A1, on which the preamble of claim 1 is based, discloses a method of maintaining a predefined droplet size or droplet volume quantity in the event of viscosity fluctuations. In order to enable a constant volume quantity due to viscosity fluctuations, the applied pressure is readjusted. Viscosity is a parameter for describing the flowability of a plastics material under the influence of a given temperature and an applied pressure. Shear-induced flowability can be compensated for by means of this control.

However, depending on the pressure and/or temperature, different materials, especially plasticizable materials, have different densities or volumes of the fluid material. As a result, the dispensed quantity is influenced by the readjustment of the pressure, which can lead to weight fluctuations in the objects produced. As a result, a corresponding control is not exact or is error-prone and therefore the process is not exactly reproducible.

Furthermore, the material quantity dispensed in the unstressed state is decisive for the resulting object weight or the resulting object density. With the updating and control systems available in the prior art, this object density, for example, cannot be precisely predefined.

US 2020/0338824 A1 discloses an extruder or a method for operating an extruder, wherein the extruder is given operating characteristics and the controller controls the axial displacement of the screw as a function of the operating characteristics. For example, the material flow of the extruder can be controlled for different materials with different viscosities. The rotational speed of the screw, the temperature and/or the pressure can also be controlled as a function of the operating characteristics.

US 2021/0154916 A1 discloses a method, wherein a pressure is recorded in a flow path during a printing process and a volume change of the material in the flow path due to compression of the material during the printing process is determined based on the pressure, and the flow rate of the material in the flow path is compensated with respect to the determined volume change of the material. For example, a melt pressure is detected and a volume change of the material due to compression of the material during the printing process is determined and the flow rate of the material is varied in order to compensate for the determined volume change.

### BRIEF SUMMARY

The disclosure addresses the problem of providing a reliable, controlled and reproducible method for dispensing reproducible discrete volumes with specific properties along a trajectory, wherein changes in properties due to differently acting process parameters are compensated.

The method of dispensing discrete volumes having certain properties along a trajectory in order to produce a three-dimensional object, e.g., a component, from at least one solidifiable material, e.g., a plastics material, that is either in a stressed state, e.g., in a fluid phase, or can be brought into a stressed state, e.g., flowable into a fluid phase, with a machine for handling and/or processing the material, in particular a molding machine or a 3D-printing machine in a process, for example a production process, has the following steps: The stressed state, e.g., the fluid phase, of the material is introduced into a material reservoir and a pressure is applied to the stressed state, e.g., the fluid phase, of the material in the material reservoir. For example, depending on the material, typical temperatures for plastics materials in the material reservoir are around 50-450° C. and typical pressures are around 50-800 bar (5-800 MPa). In principle, however, other temperatures and/or pressures can also be provided.

Furthermore, a discrete dispensing of the material takes place from an outlet opening, preferably a closable outlet opening, e.g., a nozzle or a nozzle closable by means of a closing means, under at least one process condition, e.g., at a certain pressure and/or a certain temperature for the production of the three-dimensional object, wherein, in the event of at least one change in the at least one process condition, e.g., a change in the flow property, a change in the flowability, a temperature change or another influence, at least one process parameter is updated during the production of the three-dimensional object, preferably while maintaining at least one further process parameter, in order to obtain a predefined property of the discrete volumes, for example a volume, a density, a mass and/or a temperature, in the stressed state, e.g., in the fluid phase.

For example, the pressure in the material reservoir can be readjusted due to a change in flowability in order to maintain a predefined dispensed volume per unit time in the stressed state.

In order to obtain a reliable, controlled and reproducible method for dispensing reproducible discrete volumes having certain properties along a trajectory, wherein property changes due to differently acting process parameters are compensated for, material-specific data of the material are provided and, with the aid of the material-specific data, the at least one process parameter and/or at least one further process parameter is controlled in order to obtain at least one predefined property of the discrete volumes in an unstressed state, in which no other additional external influences act on the material, e.g., a size, a volume, a density, a mass and/or a temperature, of at least one dispensed discrete volume.

Preferably, the predefined property of the discrete volumes in the unstressed state comprises the mass and/or the density. This has the advantage of increasing the reproducibility and stability of the components.

If, for example, the pressure is updated due to a change in flowability, this results in a greater mass due to the compression of the material with the same volume. If the object is produced with this volume, this results in a greater object weight. In order to advantageously obtain a predefined object weight, the dispensed volume can be changed accordingly, for example.

Due to different pressures, for example, the compression of the material may be different, which means that the dispensed quantity in the unstressed, e.g., solid state is different, and thus no reproducible process (e.g., from machine to machine) can take place. In order to make the discrete dispensed quantity (unstressed, e.g., solid state) reproducible regardless of the machine or system used, the compression of the material is also taken into account, e.g., at the particular process pressure and the given temperature. Material-specific data, e.g., pVT data, are available. The process pressure can be varied within a process in order to reduce flow property fluctuations (see document DE 10 2012 004 988 A1). In this way, the dispensed quantity of each individual droplet (discrete dispensing) can be precisely controlled-either by varying the pressure or the opening stroke or time, for example. A volume within the compressible phase in melt form is controlled in order to achieve a predefined “fixed” dispensed quantity (mass). The dispensed quantity can refer to a volume, but also to a specific mass, as the material data (e.g., material density as a function of pressure and temperature) are known. The exact component weight can therefore be calculated and output at the end of the construction process, for example, using the process data. The control is therefore not “only” based on the volume flow, as the specific density of the material in the respective state is taken into account. Instead, control is also based on a discrete dispensed mass.

For example, typical discrete deposit volumes of approx. 0.001-0.05 mm³, in particular 0.02 mm³, are possible. However, the method can also be used for other, in particular larger dispensed quantities.

For example, due to the change in flowability described above, the pressure in the material reservoir can be updated to obtain a predefined reproducible discrete material quantity. However, this pressure update causes the material to be compressed more, which means that the discontinuous volume with the predefined volume has an increased density in the stressed state. Due to the update, however, a volume with the increased density is dispensed. If this volume is dispensed, however, the increased specific density results in differences in the object weight of the produced object in the unstressed state. With the aid of the material-specific data, the at least one process parameter and/or at least one further process parameter can be changed so that the discontinuous volume in the stressed state is dispensed with a correspondingly smaller volume, for example, which nevertheless has the predefined mass in the unstressed state. By controlling the at least one process parameter and/or the at least one further process parameter as well as the material-specific data of the material in the stressed state, it is thus advantageously possible to obtain a predefined material mass and/or material quantity in the unstressed state.

If, for example, a change in flowability occurs as described above, the pressure in the material reservoir can be updated to maintain a predefined, reproducible, discrete material quantity. In the case of various materials, such as plastics materials and/or plasticizable materials, a change in the pressure load causes a change in volume as well as a simultaneous change in the material density in the stressed fluid state. Due to the change in the at least one process parameter to obtain, for example, a predefined discontinuous volume flow, the volume is readjusted to the “TARGET value” (constant discontinuous volume flow, as known, for example, from DE 10 2012 004 988 A1). An increase in pressure, for example, causes a reduction in volume with a simultaneous increase in material density in the stressed state. Due to the control for maintaining a constant volume flow, the discontinuous volume is updated or increased to the “TARGET value.” However, the material density remains unchanged in the stressed state, so that the dispensed mass of the discontinuous volume with the predefined “TARGET value” of the discontinuous volume in the unstressed state (e.g., at room pressure, atmospheric pressure, room temperature and/or an installation room temperature) is greater than before despite the same volume in the fluid stressed state. In principle, this can also happen the other way round: A reduction in pressure causes an increase in volume with a simultaneous reduction in material density in the stressed state. Due to the control to maintain a constant volume flow, the discontinuous volume is readjusted or reduced to the “TARGET value.” The material density in the stressed state remains unchanged, which means that the dispensed mass of the discontinuous volume in the unstressed state (e.g., at room pressure, atmospheric pressure, room temperature and/or an installation room temperature) is lower than before despite the same volume in the fluid stressed state.

The same applies to a change in temperature. An increase in temperature, for example, causes an increase in volume with a simultaneous reduction in material density in the stressed state. Due to the change in at least one process parameter to maintain a constant discontinuous volume flow, for example, the discontinuous volume is updated or reduced to the “TARGET value.” The material density in the stressed state remains unchanged. This has the effect that the dispensed mass in the unstressed state (e.g., at room pressure, atmospheric pressure, room temperature and/or installation room temperature) is lower than before despite the same volume in the fluid stressed state. In principle, this can also happen the other way round: A drop in temperature causes a reduction in volume with a simultaneous increase in material density in the stressed state. Due to the control to maintain a constant volume flow, the volume is controlled back to the “TARGET value.” The material density in the stressed state remains unchanged, so that the dispensed mass in the unstressed state (room pressure, atmospheric pressure, room temperature and/or installation room temperature) is greater than before despite the same volume in the fluid stressed state.

Preferably, an optimized control is used which, when a process parameter is changed, adjusts the volume in the stressed state so that the same mass is dispensed in the unstressed state as before the change. This has the advantage of achieving better reproducibility from machine to machine, since, for example, the smallest differences can be caused by manufacturing tolerances of the nozzle, which means that different masses are dispensed with the same pressure settings, for example.

Batch fluctuations and/or residual moisture differences in the material to be processed can thus also be compensated for in this way. Changes in flow properties, which are dependent on the dispensed quantity per unit time due to the resulting shear stress on the material as it flows through the dispensing nozzle, can also be compensated for, as can different temperature settings from machine to machine.

Preferably, the control for maintaining the predefined property of the discrete volumes in the unstressed state of the at least one dispensed discrete volume is performed on the basis of the updating of at least one process parameter in order to obtain a predefined property of the discrete volumes in the stressed state, e.g., in the material reservoir. For example, the control and updating can be superimposed. The control can, for example, take place after the updating of at least one process parameter, or can be superimposed or combined with it. If, for example, a certain pressure change occurs with regard to the material, which leads to a compression of the material or to the discrete volume now having a greater mass, a corresponding volume change can then take place. This results advantageously in a precise and controlled dispensing of the material.

Preferably, at least one temperature and/or pressure dependence of the specific volume, density, compressibility and/or temperature of the material, in particular a dependence of the specific volume of the material on the pressure and/or temperature, can be provided as material-specific data. Advantageously, this results in a simple relationship between different states of the material, e.g., the stressed state and the unstressed state. For example, a volume difference Δv can result from the stressed and unstressed state. In principle, other material-specific data can also be provided, as long as these show at least one relationship between an unstressed and stressed state.

For example, the material-specific data can preferably be provided as pvT data, e.g., using a pvT diagram. The material-specific data can, for example, be available as a file in a machine control system or a network. The pvT data describe the dependency of the specific volume v on the temperature T and the pressure p. For example, the specific volume can be plotted against the temperature for different pressures in a pvT diagram. The specific volume is the reciprocal of the density or vice versa. Many materials, such as plastics materials or thermoplastic materials, reduce in volume when they are cooled and expand when they are heated. Furthermore, plastics materials and thermoplastic materials are compressible, i.e., pressure reduces their volume. If different pressures or temperatures are present in the process, different material quantities are dispensed, which results in different object weights and object densities. The pvT data can, for example, be provided by the respective material manufacturers or other test laboratories, e.g., in electronic form, and, through knowledge of a multidimensional correlation of material-specific values, allow a targeted influence, e.g., on the unstressed state of the material and thus the three-dimensional object.

Advantageously for effective and simple control, a pressure, a temperature, a volume, a nozzle diameter, an opening time, a dispensing time and/or a size of the outlet opening is preferably controlled as the at least one process parameter and/or the at least one further process parameter.

Preferably, for an advantageously simple and reproducible process, the pressure is updated to obtain a predefined volume of at least one discrete volume in the stressed state and/or the volume and/or the temperature is controlled to obtain a predefined mass of at least one discrete volume in the unstressed state. If, for example, the pressure is updated due to, for example, a change in flowability, this results in a greater mass due to the compression of the material with the same volume. If the object is produced with this volume, this results in a greater object weight. In order to advantageously obtain a predefined object weight, the dispensed volume can be changed accordingly, for example.

Preferably, a corrected volume in the unstressed state is calculated using at least one ratio of the specific volume of the material in the stressed state to the specific volume of the material in the unstressed state for at least one discrete volume applied. Advantageously, this results in a simple link between the stressed and unstressed state. The link can, for example, be represented as a factor.

For example, a volume of the discrete volumes is to be kept constant at a predefined value (V(pᵢ,Tᵢ)=const). The pressure and/or temperature (pᵢ,Tᵢ) are variable and machine-dependent, resulting in a corresponding density p (pᵢ,Tᵢ) in the stressed state. For the unstressed state (pᵢ->p₀; Tᵢ>Tᵣₒₒₘ, T_{installation space}, Tₐₜₘₒₛₚₕₑᵣₑ), this results in the conservation of mass:

$$ρ ( {p}_{i} , {T}_{i} ) * V ( {p}_{i} , {T}_{i} ) = m ( {p}_{i} , {T}_{i} ) = m ( {p}_{0} , {T}_{0} ) = ρ ( {p}_{0} , {T}_{0 )} * V ( {p}_{0} , {T}_{0} )$$

with V (pᵢ,Tᵢ)=const.=c therefore follows

$$\frac{c * ρ ( {p}_{i} , Ti )}{ρ ( {p}_{0} , {T}_{0} )} = {V}_{0} ( {p}_{0} , {T}_{0} ) .$$

Further preferably, the at least one process parameter and/or the at least one further process parameter is controlled by means of at least one ratio of the specific volume of the material in the stressed state to the specific volume of the material in the unstressed state and in dependence on the temperature present. In this way, a previously defined object density can be advantageously produced.

Preferably, a total dispensed corrected volume of the material in the unstressed state is determined per produced object and/or a mass of the object is calculated using the total dispensed corrected volume of the material in the unstressed state and the material density of the material in the unstressed state. For example, by adding up the discrete volumes dispensed, a corrected volume dispensed in the unstressed state can be determined and the mass of the object can be advantageously calculated using the material density of the material in the unstressed state.

For an advantageously simple and clear diagnosis, data of the object, for example the data of the mass of the object after the process with other process-specific data, for example the production time and parameters, for example pressure, temperature and dispensed quantity per production progress, can preferably be displayed, logged and/or stored.

If no material-specific data are available or if these are unknown, the material-specific data can preferably be provided by at least one measurement with the machine. The measurement can also preferably be carried out before or during the execution of the process. For example, the displaced volume or the pressure-dependent compressibility in a cylinder, e.g., as a mass cushion, can be measured before or during a process, which advantageously results in the material-specific data. This procedure can be advantageous if the material-specific data of the material is insufficient or not known. In particular, this can be done with special materials, such as material compounds, recyclates or bio-based materials or material combinations.

For an advantageously accurate provision of the material-specific data, at least one position, for example a screw position, a volume, a pressure and/or a temperature, is preferably detected for the measurement with the machine. For example, the specific material expansion can be determined by means of the expansion of the material at different temperatures and the resulting displacement, for example of the screw to the rear. For example, the compressibility at different pressure levels can also be determined for a temperature (isothermal compressibility or volume expansion) by detecting the change in the screw position.

In order to make it possible to provide the material-specific data quickly and easily, at least one calibration can preferably be used to adjust the total dispensed corrected volume for different process conditions and/or machine conditions. An adjustment factor can preferably be used for a more precise determination of the dispensed volume and/or the dispensed mass.

In order to advantageously enable a transfer of the method to a continuous dispensing, for example a strand, a flow rate per unit time can preferably be calculated from the total dispensed corrected volume and/or the flow rate per unit time is varied. This can be used, for example, to calculate the existing shear rate or the shear on the material as it exits the outlet opening, for example from the nozzle, or this can be specifically controlled by varying the flow rate. This is an advantageous way of controlling the molecular orientation to influence the mechanical properties.

In order to achieve advantageous control of the molecule orientation to influence the mechanical properties, a temperature change can preferably be used to further influence the shear, taking into account the material-specific data, e.g., the pvT diagrams and/or the predefined dispensed quantity.

Preferably, the material undergoes at least one phase transition between the stressed state and the unstressed state. This allows special properties of the material's phase transition to be used advantageously. For example, plastics materials or thermoplastic materials reduce their volume when they are cooled and expand when they are heated. In a diagram, e.g., a pVT diagram, a phase transition, e.g., from the solid to the fluid or deformable state of the material, is expressed as a “kink” (change in gradient of the straight line), which defines, for example, the glass transition temperature or softening temperature in the respective isobars. There is a clear difference in density between the unstressed and stressed states, as the molecular chains contract much more tightly during the transition to the solid phase.

The disclosure provides also a machine control system for a machine for handling and/or processing the material, in particular a molding machine or a 3D printing machine, which is set up, embodied and/or constructed to carry out the method.

The disclosure provides also a corresponding computer program product with a program code which is stored on a computer-readable medium and is suitable for carrying out the method.

Further advantages can be found in the dependent claims and the following description of a preferred exemplary embodiment. The features listed individually in the claims can be combined with one another in a technically meaningful way and can be supplemented by explanatory facts from the description and by details from the figures, wherein further variants are shown.

### BRIEF DESCRIPTION OF THE FIGURES

In the following, the disclosure is explained in greater detail with reference to an exemplary embodiment shown in the appended Figures, in which:

FIGS. 1, 2 show pvT diagrams to describe updating and control,

FIGS. 3, 4 show pvT diagrams of a material,

FIG. 5 shows a partially sectioned view of a machine for handling and/or processing the material,

FIG. 6 a schematic diagram relating to the influence on the shear viscosity and/or the shear rate.

### DETAILED DESCRIPTION

The disclosure will now be explained in greater detail by way of example with reference to the accompanying drawings. However, the embodiments are only examples and are not intended to limit the inventive concept to a particular arrangement.

Before describing the disclosure in detail, it should be pointed out that it is not limited to the respective components of the device or the respective method steps, as these components and methods may vary. The terms used herein are merely intended to describe particular embodiments and are not used in a limiting manner. Moreover, when the singular or indefinite articles are used in the description or in the claims, this also refers to the plurality of these elements, unless the overall context clearly indicates otherwise.

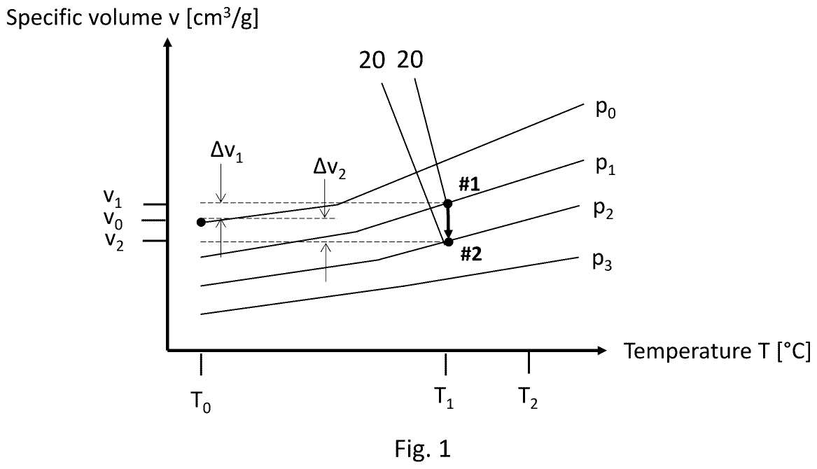

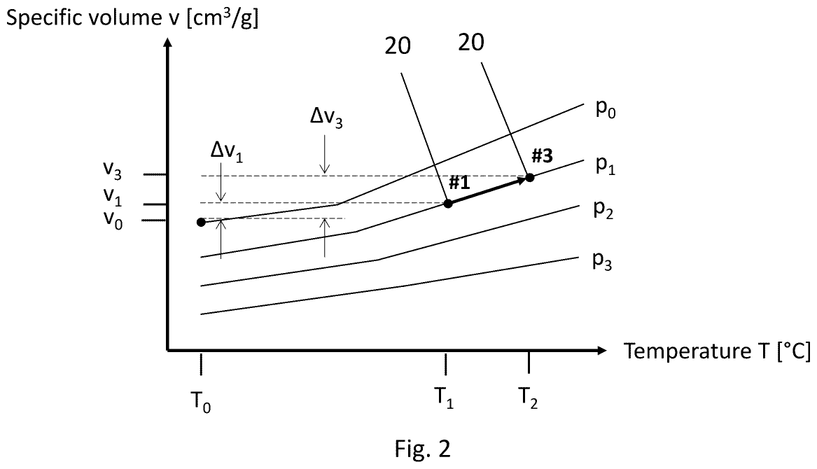

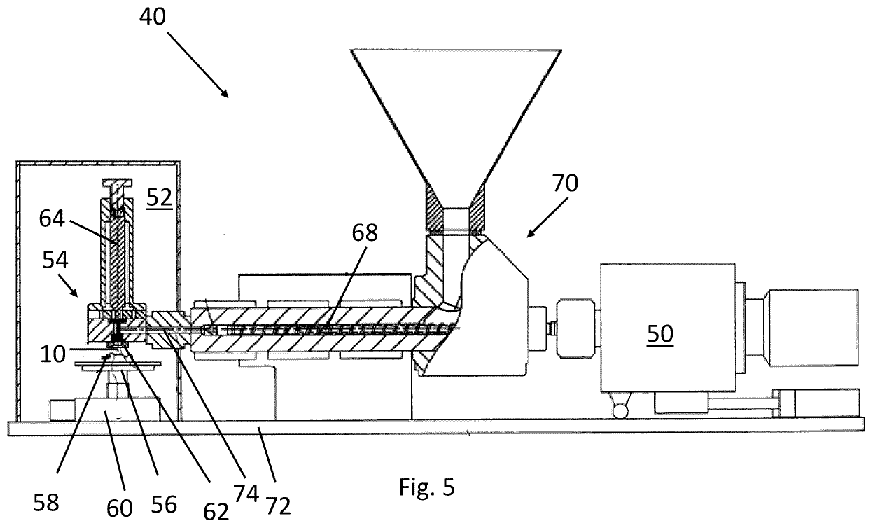

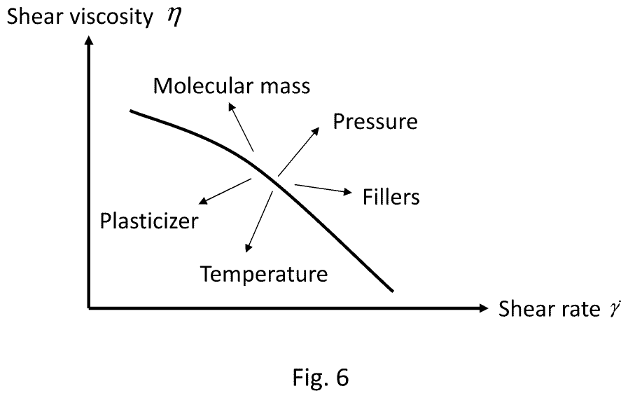

Before discussing the method sequence according to FIGS. 1 and 2, the machine 40 for handling and/or processing the material to produce a three-dimensional object 58, e.g., a component made of solidifiable material according to FIG. 5, will first be explained.

The material, which is either in a stressed state, for example in a fluid phase, or can be brought into a stressed state, for example flowable, is used in order to produce a three-dimensional object 58 by sequentially dispensing discrete volumes 10. This can be done, for example, by dispensing individual discrete volumes 10 sequentially from an outlet opening 62 of a dispensing unit 54, so that the object 58 is formed layer by layer on an object carrier 56 in an installation space 52, which object carrier can be moved relative to the outlet opening 62 by a drive unit 60. The solidifiable material may be a plasticized material, such as silicone, or a plasticizable material, such as thermoplastics. Any other materials can be used, as long as these materials can be solidified and preferably plasticized by the machine and, in particular, can be dispensed by the at least one dispensing unit 54.

The material is plasticized or prepared and/or homogenized under the influence of temperature in the preparation unit 70 arranged on a machine table 72 and pressurized by the pressure generation unit 50. Depending on the present flow properties of the material, the pressure is set accordingly for the dispensing of the discrete volumes 10 for producing the object 58, given the opening time of the nozzle and/or the size of the outlet opening 62. The discrete volumes 10 are in particular in the range from 0.01 to 1 mm³. The diameter of the outlet opening 62 is in particular less than or equal to 1 mm, preferably between 0.1-0.5 mm. The fluid phase of the material located in the material reservoir 74 can be dispensed to the object 58 via an outlet opening 62, actuated by a drive part 64. A solid-state joint according to DE 10 2009 030 099 B1 can preferably be used as an orifice plate at the outlet opening 62. The processed material is generally a so-called non-Newtonian fluid. Their flow properties are strongly dependent on the existing process settings such as temperature, pressure, dwell time under temperature, degree of drying of the starting solid, etc. and also the flow rate and the resulting shear stress on the material. Even the smallest changes influence the dispensed quantity, but the layer structure of an object 58 to be formed, which is calculated in particular from the CAD models, is preferably based on a constant discrete dispensed quantity.

FIG. 1 shows the specific volume (v) in dependence on pressure (p) and temperature (T) in a so-called pvT diagram for a typical amorphous material. These data can be provided as material-specific data in a further preferred exemplary embodiment. In each case, the specific volume is plotted as a function of temperature for different pressures. The specific volume is the reciprocal of the density or vice versa. Various materials, e.g., plastics materials or thermoplastic materials, reduce in volume when they are cooled and expand when they are heated. In addition, plastics or thermoplastic materials are compressible, i.e., pressure reduces their volume.

FIG. 1 also a phase transition from the solid to the fluid or deformable state of the material. In the pVT diagram in FIG. 1, the phase transition can be recognized as a “kink” (=glass transition temperature or softening temperature) in the respective isobars (p₀, p₁, p₂, p₃). There is a clear difference in density here, as the molecular chains contract much more tightly during the transition to the solid phase.

FIG. 1 shows the dependence of the process parameters in the fluid phase on the dispensed material quantity in the non-stressed state as well as various operating points 20, which represent different process settings. To dispense discrete volumes 10 in order to produce a three-dimensional object 58 from at least one solidifiable material, which is either present in a stressed state, e.g., in a fluid phase, or can be brought into a stressed state, e.g., can be flowed into a fluid phase, with a machine 40 for handling and/or processing the material, in particular a molding machine or a 3D printing machine, in a process the stressed state of the material is introduced into a material reservoir 74 and a pressure as well as a temperature effect generate a stressed state of the material in the material reservoir 74. Furthermore, a discrete dispensing of the material from a pulsable and/or closable outlet opening 62 to build up the three-dimensional object 58 takes place under at least one process condition. This corresponds, for example, in FIG. 1 to the operating point 20 #1 with the specific volume v₁ (T₁,p₁). If the discrete volume 10 with the volume V₁ is dispensed with the machine under these process conditions (T₁, p₁), a predefined mass m₁=V₁*1/v₁=V₁*ρᵢ is consequently dispensed.

If the process conditions undergo at least one change, e.g., if the material undergoes a change in flow properties, a change in flowability, a change in temperature and/or a change due to other influences, which is detected in the stressed state, this change is compensated for. In order to compensate for this at least one change and to obtain a predefined property of the discrete volumes 10, e.g., a predefined size, at least one process parameter, e.g., the pressure p₁, is updated in FIG. 1 (p₁->p₂). This results, for example, in a higher pressure: p₂>p₁ (operating point 20 #2 in FIG. 1). However, the greater pressure p₂ leads to a change in the discrete volume 10, e.g., to a smaller volume V₂ and a change in the density, e.g., to a greater density p₂ of the discrete volume 10. Since the pressure was updated as a process parameter in order to enable a predefined size with the predefined volume V₁, the volume V₁ would be dispensed with a mass m₂=V₁*ρ₂>m₁. However, this would have the disadvantage of leading to different object masses, for example, and thus to non-previously defined object densities.

Material-specific data of the material are provided, wherein the volume is controlled with the aid of the material-specific data in such a way that, for example, a predefined mass m₁=V₂*ρ₂ is obtained in an unstressed state, e.g., at room temperature and/or room pressure, of a dispensed discrete volume 10. In principle, the volume can also be controlled accordingly if a lower pressure is used to obtain the size due to changes in the process conditions (p₁>p₂). The volume can then be increased accordingly to obtain the predefined mass m₁. This results in optimized control, which, for example, adjusts the volume in the stressed state when the pressure changes so that the same mass is dispensed in the unstressed state as before the pressure change.

FIG. 2 shows a further example of updating and control for a further exemplary embodiment. At the operating point 20 #1, a discrete volume 10 with a volume V₁ and a density pᵢ is present, which was introduced into the material reservoir 74 under various process conditions, for example at a temperature T₁ and a pressure p₁. If the discrete volume 10 is dispensed with the machine, a predefined mass m₁=V₁*ρ₁ is consequently dispensed. In order to compensate for a change, e.g., due to a change in flowability and/or due to another influence that is detected in the stressed state, and to obtain a predefined property of the discrete volumes 10, e.g., a predefined size, the temperature T₁ is updated in FIG. 2 (T₁->T₂). This results, for example, in a higher temperature: T₂>T₁ (operating point 20 #3 in FIG. 2), which leads to a change in the discrete volume 10. Since the temperature was updated to obtain a predefined size with the predefined volume V₁, if the volume V₁ was dispensed, a mass m₃=V₁*1/v₃=V₁*ρ₃≠m₁ or m₃<m₁ would consequently be dispensed. This would also lead, for example, to different object masses and, as a result, to non-previously defined object densities.

Material-specific data of the material is provided, wherein the discrete volume 10 is controlled with the aid of the material-specific data in such a way that, for example, a predefined mass m₁=V₂*ρ₃ is obtained in the unstressed state of a dispensed discrete volume 10. In principle, the volume can also be controlled accordingly if a lower temperature is used to obtain the size due to changes in the process conditions (T₁>T₂). The volume can then be changed accordingly to obtain the predefined mass m₁. This results in optimized control, which, for example, adjusts the volume in the fluid phase when the temperature changes so that the same mass is dispensed in the unstressed state as before the temperature change.

In another preferred exemplary embodiment, the material is present in the nozzle in molten form and is pressurized. By opening the nozzle, e.g., a needle valve, the material can flow out of the nozzle. The pressure therefore determines the dispensed quantity per opening stroke of the nozzle, e.g., a needle valve nozzle, and is virtually constant throughout the process, i.e., independent of the dispensing rate. Due to different needle/nozzle pairings, different pressures must be applied in order to keep the dispensed quantity constant. Due to the different pressures, however, the compression of the material is also different, which means that the dispensed quantity is different in the unstressed, e.g., solid state, and therefore no reproducible process (e.g., from machine to machine) can take place.

In order to make the discrete dispensed quantity (unstressed, e.g., solid state) reproducible regardless of the machine or system used, the compression of the material is also taken into account, e.g., at the respective process pressure and the given temperature. Material-specific, e.g., pVT data is available. The process pressure within a process is varied in order to reduce flow property fluctuations (see document DE 10 2012 004 988 A1). Of course, this must also be increased if the dispensing is to be increased with the same opening stroke of the needle.

In this way, the dispensed quantity of each individual droplet (discrete dispensing) can be precisely controlled-either by varying the pressure or the opening stroke or time. A volume is controlled within the compressible molten phase in order to achieve a predefined “fixed” dispensed quantity (mass). The dispensed quantity can refer to a volume, but also to a specific mass, as the material data (e.g., material density as a function of pressure and temperature) are known. The exact component weight can therefore be calculated and output at the end of the construction process, for example, using the process data. The control is therefore not “only” based on the volume flow, as the specific density of the material in the respective state is taken into account. Rather, control is also based on a discrete dispensed mass.

In a preferred exemplary embodiment, the predefined property of the discrete volumes 10 in the unstressed state comprises the mass and/or the density.

In a further preferred exemplary embodiment, the control in order to obtain the predefined property of the discrete volumes 10 in the unstressed state of the at least one dispensed discrete volume 10 is performed based on the updating of the at least one process parameter in order to obtain a predefined property of the discrete volumes 10 in the stressed state. For example, the control in order to obtain a predefined mass in the unstressed state of the dispensed discrete volume 10 starts after the updating of the pressure in the stressed state.

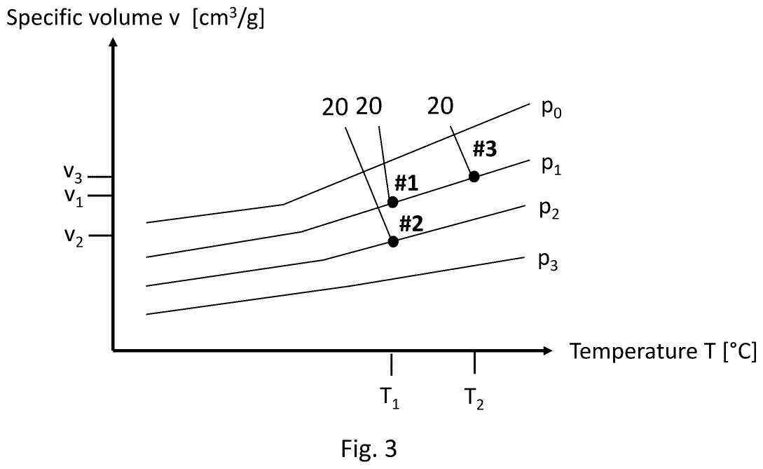

FIG. 3 shows an example of the specific volume (v) as a function of pressure (p) and temperature (T) in a pvT diagram for an ABS material called Terluran GP35. Three operating points 20 #1, #2 and #3 are marked, wherein either the process pressure or the temperature is different in each case. Each change causes a change in the specific volume. For example, at operating point 20 #1 with the process conditions of T₁=240° C. and p₁=200 bar, the material has a specific volume of v₁=1.047 cm³/g and a specific density of ρ₁=0.955 g/cm³. For a displaced discrete volume of 0.01 mm³, this results in a mass m₁ of 0.01 mm³*0.000955 g/mm³=0.00000955 g. If the process conditions change to the operating point 20 #2 with T₁=240° C. and p₂=400 bar, this results in a specific volume of v₂=1.035 cm³/g or a specific density of ρ₂=0.967 g/cm³. For a displaced discrete volume of 0.01 mm³, this results in a mass m₂ per droplet of 0.01 mm³*0.000967 g/mm³=0.00000967 g.

At the operating point 20 #3, for example, the process conditions of T₂=250° C. and p₁=200 bar are present, resulting in a specific volume of v₃=1.020 cm³/g or a specific density of ρ₃=0.951 g/cm³. For a displaced discrete volume of 0.01 mm³, this results in a mass m₃ of 0.01 mm³*0.000951 g/mm³=0.00000951 g. Thus, for example, for a produced object with a volume of 21135 mm³ or 21.135 cm³ and 1,569,073 dispensed discrete volumes, the following different object weights result: weight at 240° C./200 bar: 14.98 g; weight at 240° C./400 bar: 15.17 g; weight at 250° C./200 bar: 14.92 g.

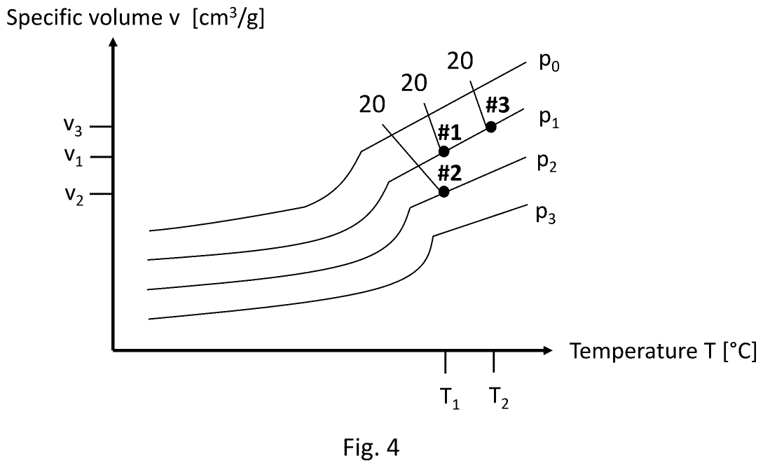

Similar results are obtained for partially crystalline thermoplastics. In this material group, the temperature-dependent volume change is more pronounced. FIG. 4 shows a pvT diagram for a typical partially crystalline material. If we now take a polyamide, e.g., PA6 Ultramid B3K, as an example, this also results in different object weights for three different operating points 20 #1, #2 and #3.

At operating point 20 #1 with the process conditions of T₁-250° C. and pᵢ=200 bar, a specific volume of v₁=1.0168 cm³/g or a specific density of ρ₁=0.984 g/cm³. For a displaced discrete volume of 0.01 mm³, this results in a mass m₁ of 0.01 mm³*0.000984 g/mm³=0.00000984 g. If the process conditions change to the operating point 20 #2 with T₁=250° C. and p₂-400 bar, this results in a specific volume of v₂=1.0006 cm³/g or a specific density of ρ₂-0.994 g/cm³. For a displaced discrete volume of 0.01 mm³, this results in a mass m₂ per droplet of 0.01 mm³*0.000994 g/mm³=0.00000994 g.

At operating point 20 #3, for example, the process conditions are T₂=260° C. and p₁=200 bar, which results in a specific volume of v₃=1.022 cm³/g or a specific density of ρ₃=0.979 g/cm³. For a displaced discrete volume of 0.01 mm³, this results in a mass m₃ of 0.01 mm³*0.000979 g/mm³=0.00000979 g. Thus, for example, for a produced object with a volume of 21135 mm³ or 21.135 cm³ and 1,569,073 dispensed discrete volumes, the following different object weights result: weight at 250° C./200 bar: 15.44 g; weight at 250° C./400 bar: 15.60 g; weight at 260° C./200 bar: 15.36 g.

The discrete volume 10 is controlled, for example by adjusting the outlet opening 62, so that in the unstressed state the mass is dispensed that would have been dispensed initially, i.e., without a pressure update. In principle, however, the pressure, the temperature, the nozzle diameter, the opening time of the nozzle, the dispensing time and/or the size of the outlet opening 62 could also be controlled accordingly.

In a further preferred exemplary embodiment, the pressure is updated in order to obtain a predefined volume of at least one discrete volume 10 in the stressed state, e.g., in the fluid phase, and the volume and/or the temperature is controlled in order to obtain a predefined mass of at least one discrete volume 10 in the unstressed state.

In a further preferred exemplary embodiment, a corrected volume in the unstressed state can be calculated for at least one dispensed discrete volume 10 using at least one ratio of the specific volume of the material in the stressed state to the specific volume of the material in the unstressed state.

In a further preferred exemplary embodiment, the at least one process parameter and/or the at least one further process parameter can be controlled by means of at least one ratio of the specific volume of the material in the stressed state to the specific volume of the material in the unstressed state and in dependence on the temperature present.

In a further preferred exemplary embodiment, a total dispensed corrected volume of material in the unstressed state can be determined per produced object 58 and/or a mass of the object 58 can be calculated using the total dispensed corrected volume of material in the unstressed state and the material density of the material in the unstressed state. For example, this can be done according to FIG. 1 or FIG. 2 by means of the difference of the specific volume from the stressed fluid state to the unstressed state (TO, p0).

It is possible that the material-specific data of the material is not available because the material is an unidentified recyclate or compound, for example. In another preferred exemplary embodiment, the material-specific data can be provided by at least one measurement with the machine.

In order to obtain the material-specific data through the measurement, at least one position, e.g., a screw position, a volume, a pressure and/or a temperature is detected in a further preferred exemplary embodiment. From this, it is advantageous to derive a ratio of the specific volume in the screw to the volume in the atmosphere. This allows the process to be adapted in the fluid phase, as already described.

For an advantageously more precise determination of the dispensed volume or the dispensed mass, in a further preferred exemplary embodiment, at least one calibration can be used to adjust the total dispensed corrected volume for different process conditions. This allows a corresponding adjustment factor to be used for a more precise determination of the dispensed volume or the dispensed mass. In principle, this can correspond to a volume difference Δv, e.g., Δv₁, Δv₂ or Δv₃ in FIG. 1 or 2.

In a further preferred exemplary embodiment, a flow rate per unit time can be calculated from the total dispensed corrected volume and/or the flow rate per unit time can be varied. From this, the existing shear rate or the shear on the material at the exit from the outlet opening 62 can be calculated or specifically controlled by varying the flow rate.

In order to advantageously achieve control of the molecule orientation to influence the mechanical properties, in a further preferred exemplary embodiment, a temperature change could be used to further influence the shear, taking into account the material-specific data, e.g., the pvT data, the pvT diagrams and/or the predefined dispensed quantity.

The advantages cited with regard to the method also arise in the case of a machine control system for a machine 40 for handling and/or processing the material, in particular a molding machine or a 3D printing machine, provided that the machine control system is set up, embodied and/or constructed to carry out the method accordingly.

Similarly, the advantages according to the method arise when using a computer program product with a program code that is stored on a computer-readable medium, so that the method can be carried out using the program code.

It goes without saying that this description may be subject to a wide range of modifications, changes and adaptations which are within the scope of equivalents to the appended claims.

1.-16. (canceled)

17. A method of dispensing discrete volumes having certain properties along a trajectory in order to produce a three-dimensional object from at least one solidifiable material that is either in a stressed state or can be brought into a stressed state, comprising a machine for at least one of handling or processing the material, comprising the steps of:
placing the stressed state of the material in a material reservoir,
applying a pressure to the stressed state of the material in the material reservoir,
discretely dispensing the material from a pulsable, closable outlet opening in order to produce the three-dimensional object under at least one process condition,
wherein, upon at least one change of the at least one process condition, at least one process parameter is updated during the production of the three-dimensional object, while maintaining at least one further process parameter, in order to obtain a predefined property of the discrete volumes in the stressed state,
wherein material-specific data of the material are provided, and wherein the material-specific data are used to control at least one of the at least one process parameter or at least one further process parameter in order to obtain at least one predefined object density of the discrete volumes in an unstressed state, in which no other additional external influences act on the material, of at least one of the dispensed discrete volumes.

18. A method in accordance with claim 17, wherein the control for obtaining the predefined object density of the discrete volumes in the unstressed state of the at least one dispensed discrete volume is carried out on the basis of the updating of the at least one process parameter for obtaining a predefined property of the discrete volumes in the stressed state.

19. A method in accordance with claim 17, wherein at least one of data of the following group of data is provided as material-specific data:
temperature dependence of the specific volume,
temperature dependence of the density,
temperature dependence of the compressibility,
temperature dependence of the temperature of the material,
pressure dependence of the specific volume,
pressure dependence of the density,
pressure dependence of the compressibility,
pressure dependence of the temperature of the material.

20. A method in accordance with claim 19, wherein a dependence of the specific volume of the material on at least one of the pressure or the temperature is provided as material-specific data.

21. A method in accordance with claim 17, wherein one parameter of the following group is controlled as at least one of the at least one process parameter or the at least one further process parameter:
a pressure,
a temperature,
a volume,
a nozzle diameter,
an opening time,
a dispense time,
a size of the outlet opening.

22. A method in accordance with claim 17, wherein the pressure is updated to obtain a predefined volume of at least one discrete volume in the stressed state.

23. A method in accordance with claim 17, wherein at least one of the volume or the temperature is controlled to obtain a predefined mass of at least one discrete volume in the unstressed state.

24. A method in accordance with claim 17, wherein a corrected volume in the unstressed state is calculated by means of at least one ratio of the specific volume of the material in the stressed state to the specific volume of the material in the unstressed state for at least one dispensed discrete volume.

25. A method in accordance with claim 17, wherein at least one of the at least one process parameter or the at least one further process parameter is controlled by means of at least one ratio of the specific volume of the material in the stressed state to the specific volume of the material in the unstressed state and in dependence on the prevailing temperature.

26. A method in accordance with claim 17, wherein a total dispensed corrected volume of the material in the unstressed state is determined per produced object.

27. A method in accordance with claim 17, wherein a mass of the object is calculated with the aid of the total dispensed corrected volume of the material in the unstressed state and the material density of the material in the unstressed state.

28. A method in accordance with claim 17, wherein the material-specific data are provided by at least one measurement with the machine.

29. A method in accordance with claim 12, wherein at least one of a position, a volume, a pressure or a temperature is detected for the measurement with the machine.

30. A method in accordance with claim 25, wherein a flow rate per unit time is calculated from the total dispensed corrected volume.

31. A method in accordance with claim 25, wherein the flow rate per unit time is varied.

32. A method in accordance with claim 17, wherein the material undergoes at least one phase transition between the stressed state and the unstressed state.

33. A machine control system for a machine for at least one of handling or processing a solidifiable material, wherein the machine control system and the machine are set up, executed and/or constructed to carry out the method in accordance with claim 17.

34. A computer program product comprising a program code stored on a computer-readable medium and being executable in a machine control system of a machine according to claim 17.
